(19) United States
(12) Patent Application Publication
(10) Pub. No.: US 2007/0003911 A1
(43) Pub. Date: Jan. 4, 2007

(54) Method and system for cartographic projection of the terrestrial globe and map produced by this method

(76) Inventor: Julien Serre, Carrieres-Sur-Seine (FR)

Correspondence Address: OSTROLENK FABER GERB & SOFFEN, 1180 AVENUE OF THE AMERICAS, NEW YORK, NY, 100368403, US

(21) Appl. No.: 11/177,108

(22) Filed: Jul. 8, 2005

(30) Foreign Application Priority Data
Jun. 29, 2005 (FR) 05 51831

(51) Int. Cl. G09B 25/06

(52) U.S. Cl. 434/130

(57) ABSTRACT

According to the method, a projection cylinder, containing the globe (1) or secant to it, is defined, and the points on the globe, whose coordinates are defined by a longitude (φ) and a latitude (θ) are projected on to this cylinder by associating an abscissa (X) with each longitude (o) and an ordinate (Y), with each latitude (φ) with in a frame of reference of the developed cylinder (2), characterized in that:
a sequence of n+1 angles of latitude (θ₀, . . . , θₙ) is determined, defining n (n≧2) distinct ranges of latitude,
each northern and/or southern hemisphere of the globe (1) is divided into n peripheral latitude zones (4) corresponding to the n ranges of the sequence, each being defined by two parallels (5, 6) of limit latitude,
the parallels of limit latitude (5, 6) are projected on to the projection cylinder, and
each point (A) of one of the n latitude zones (4) is projected into a point (A′) on the cylinder, whose ordinate is contained and interpolated between those of the projected parallels of limit latitude, according to the relative latitude (a) of the point (A) between the two parallels (5, 6).

The invention relates to a method for the cartographic representation of the terrestrial globe.

In order to obtain a cartographic representation of a portion of the surface of the terrestrial globe, or even of the whole of the terrestrial globe, various methods of projecting the surface of the globe on to a plane are used. The following examples may be cited:
cylindrical projection, in which the various points on the surface of the globe are projected on to a cylinder tangent or secant to this surface, after which the cylinder is developed to form a plane;
conical projection, in which the points are projected on to a cone tangent or secant to the surface of the globe, after which the cone is developed to form a plane;
azimuthal projection, directly on to a plane tangent or secant to the globe.

Beyond the geometric projections mentioned above, it relates, in practice, to implementing a method in which the vectorial coordinates of the points on the terrestrial globe, generally comprising the distance to the centre of the globe, the longitude and the latitude of each point, are converted into coordinates on the projection surface concerned, in the desired environment, for example an information technology environment. Such a method is generally used with information technology means and enables maps to be generated and displayed on the basis of vectorial coordinates of points on the surface of the globe.

The problem which gave rise to the invention is a problem of interactive cartography on the Internet. Some Internet sites offer a map generation service, in which, following the input of an address by a user, a server for implementing the service generates a map of a specified portion of the surface of the globe located in the vicinity of this address, at a specified scale. The maps have been divided in advance into linking “tiles”, enabling the user to increase or decrease the scale, or to move the map in a given direction, simply by sliding it with the cursor; for these operations, the server loads only the missing tiles required for the desired display.

Because of their application to the Internet, these services require a method of generating maps with approximations, to prevent the calculations, and consequently the data loading times, from being too lengthy.

Such a system, applied in the United States of America, is known; this uses a method in which the following approximations are made: the terrestrial globe is considered to be spherical and the projection is made on to a cylinder secant to the surface of the terrestrial globe along a line located approximately in the middle of the United States in terms of latitude, in other words at a latitude of 39.5°. The projected coordinates are directly proportional to the angles of longitude and latitude, with a correction ratio of cos(39.5) for the latitudes, so that the longitude distance are preserved, the latitude error being zero at the latitude of 39.5° and increasing with distance from this latitude. Although the approximation is satisfactory for the generation of a map of part of the United States, or even for the United States as a whole, considerable distortions appear if a map of Alaska, for example, is to be generated. This is because, while the longitudinal distances are maintained, the distances in respect of latitude are contracted, this change being proportional to the cosine of the angle of latitude. The latitude coordinates are increasingly contracted with increasing distance from the line secant to the cylinder. Thus, for North Alaska, in other words for a latitude of 70°, the error is more than 55% ((cos(39.5)−cos(70))/cos(39.5)≈0.55), causing an unacceptable contraction of the represented portions of surface. If this method is applied to Europe, which extends from a latitude of 35.5° in southern Spain to 71° in northern Sweden, and a median line secant to the cylinder at a latitude of 55° is used for the distortions, this yields distortions of plus or minus 43%, which are unacceptable.

There is also a known system called UTM (Universal Transverse Mercator), in which the terrestrial globe is divided into zones with an amplitude of 6° in longitude and bands with an amplitude of 8° in latitude, projected on to cylinders whose axes lie in the plane of the equator. The projection function, in other words the function which associates a projected point with each point of the globe, is more complex than in the preceding case, because it takes into account, and compensates for, the contraction as the distance from the secant curves between the projection cylinder and the terrestrial globe increases, as well as the elliptical shape of the terrestrial globe. Although this system yields excellent results in terms of accuracy and uniformity of maps, and, in particular, could provide uniform approximations for the whole of Europe, it is not applicable to a system of map generation on the Internet, in which the ability to generate a map of any portion of the terrestrial globe is desirable. This is because there is an excessive quantity of data to be processed, which considerably slows down the server responsible for the service and makes the system much less user-friendly. It is also very difficult to divide the resulting maps into linking tiles. Although the UTM system is very efficient for positioning operations, it thus appears to be more difficult to implement for map generation or display.

It is true that we are concerned here with applications for general public use, in which approximations, and consequently distortions, are acceptable. The users are also accustomed to these distortions—in particular, the approximation of a spherical globe is currently used—in the maps which they view, and therefore they are not troubled by the distortions, provided that these are not too great and provided that the shapes of regions or countries are retained. However, they require a very fast provision of the service.

For this kind of service, it is also frequently desirable to be able to enhance the map with “overlays” comprising, for example, the names of various elements (names of streets, regions, monuments, etc., which are projected on to the map, for example) and/or with images (such as satellite images) or representations of the relief, which are superimposed on the map. The overlays are superimposed on the tiles into which the map is divided. The UTM system is too complex to allow such overlaying or superimposition of an image, while a system with excessive distortion would create erroneous displays.

The object of the present invention is to propose a method for the cartographic projection of at least a portion of the terrestrial globe which meets the following requirements:
simplicity of the projection method and of the corresponding calculations;
approximations, and consequently distortions, which are acceptable to the user;
the possibility of generating a map of any portion of the terrestrial globe, or a map of the globe as a whole, in a predetermined way;
the possibility of implementing a method of dividing into linking tiles in the map for an Internet map generation application;
the possibility of adding superimposed overlays to the tiles into which the map is divided.

The invention therefore relates to a method for the cartographic projection of at least a portion of the terrestrial globe, in which a projection cylinder, containing the globe or secant to it, is defined, and the points on the globe, whose coordinates are defined by longitudes and latitudes, are projected on to this cylinder, by associating an abscissa with each longitude and an ordinate with each latitude in a frame of reference of the developed cylinder, characterized in that:
the terrestrial globe is approximated to a sphere,
a sequence of n+1 angles of latitude (θ₀, θₙ) is determined, defining n (n≧2) distinct ranges of latitude,
each northern and/or southern hemisphere of the globe is divided into n peripheral latitude zones corresponding to the n ranges of the sequence, each being defined by two parallels of limit latitude,
the parallels of limit latitude are projected on to the projection cylinder, and
each point of one of the n latitude zones is projected into a point on the cylinder, whose ordinate is contained and interpolated between those of the projected parallels of limit latitude, according to the relative latitude of the point between the two parallels.

The approximation of the terrestrial globe to a sphere is not an essential step in the application of the method, and the applicant does not intend to limit the scope of his rights to this approximation. It is a preferred embodiment of the method, particularly for application to the generation of interactive maps on the Internet, where the map is divided into tiles. The simplicity of the application of the invention also permits its use in a projection method in which the terrestrial globe is approximated, for example, to an ellipsoid, the projection being adapted to this approximation; this method is also applicable to the interactive generation of maps on the Internet.

The invention is particularly applicable to the generation of maps on the Internet, but the applicant does not intend to limit the scope of his rights to this sole application.

The invention also relates to a system for the cartographic projection of at least a portion of the terrestrial globe, for the implementation of a projection method applied to interactive cartography on the Internet, comprising:
a database containing the coordinates of the points on the portion of the globe, each defined by a longitude and a latitude,
a database containing the latitude coordinates of a sequence of n+1 limit angles of latitude,
a cylindrical projection program, which associates an ordinate with each latitude,
a module for calculating, by means of the program, the projected ordinates of the n+1 limit angles of latitude,
a module for comparing the coordinates of the points on the portion of the globe with the database containing the coordinates of the limit latitudes of the sequence,
a module for calculating the projected coordinates of the points on the portion of the globe, designed to calculate the projected ordinate of each point by interpolation between the values of the projected ordinates of the angles of limit latitude between which the latitude of the point is located, and
a module for generating an interactive map on the Internet on the basis of the calculated values of the projected coordinates.

Clearly, the invention also relates to the maps produced by the method according to the invention, regardless of their media.

The invention will be more clearly understood with the aid of the following description of the preferred embodiment of the method according to the invention, with reference to the attached sheets of drawing, in which:

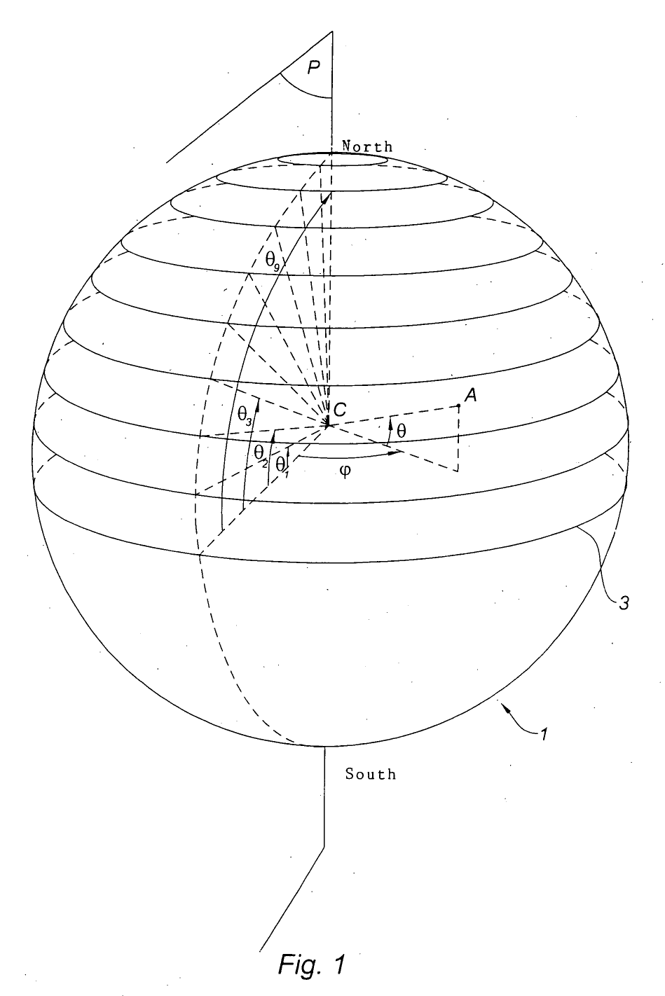

FIG. 1 shows a schematic view of the terrestrial globe in which the northern hemisphere is divided into nine latitude zones,

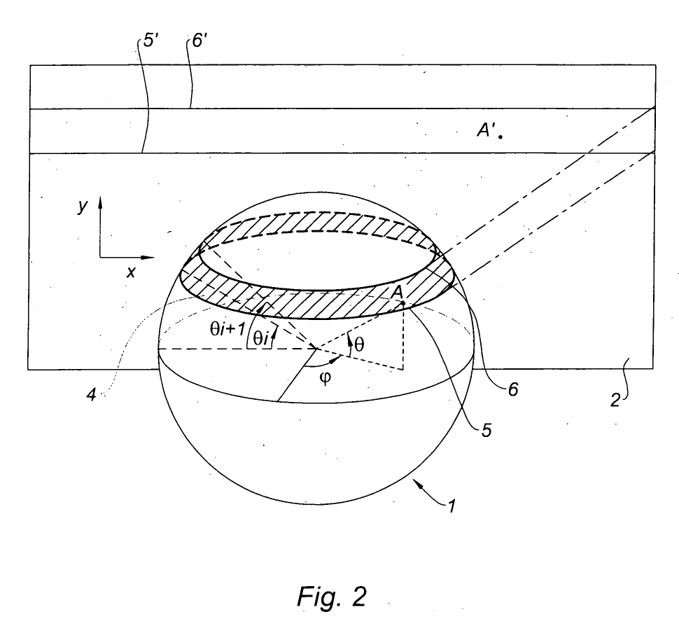

FIG. 2 shows a schematic view illustrating the projection of a point contained in a zone on to the developed cylinder,

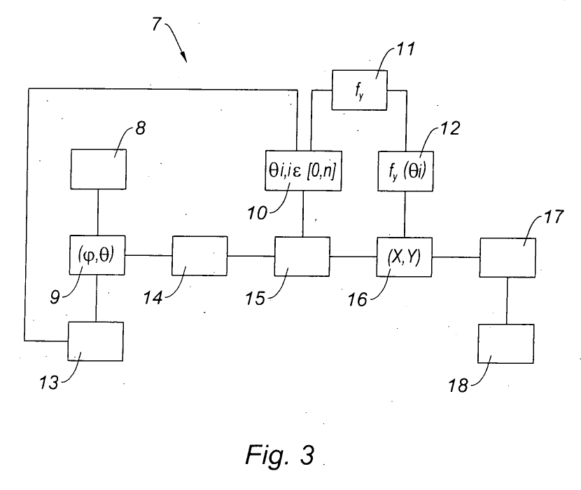

FIG. 3 is a flow chart showing a cartographic projection system for implementing the preferred embodiment of the method according to the invention, and
the appendix contains a computer program in C language which can be used to implement the preferred embodiment of the method according to the invention.

The object of the method according to the invention is to obtain a cartographic projection of a portion of the terrestrial globe, or even of the whole globe.

With reference to FIG. 1, a preliminary approximation has been made here: the terrestrial globe 1 is approximated to a sphere. This approximation is used in an extended way in the cartographic projection methods, and is not unacceptable to the user of the map to be produced by the cartographic projection method, since the user is accustomed to this approximation. A person skilled in the art may prefer an approximation of the shape of the terrestrial globe to an ellipsoid, for example if he wishes to obtain a greater accuracy of the cartographic representation.

In this spherical frame of reference, each point A on the surface of the terrestrial globe 1 is defined by two of its coordinates, namely the longitude φ and the latitude θ, which are well known to those skilled in the art. The distance to the centre C of the terrestrial globe 1 is not an essential coordinate for the determination of the coordinates of a point A, since this distance is considered to be constant because of the approximation of the globe 1 to a sphere; also, the altitude of the points is disregarded in this case.

A projection cylinder, on to which the points on the surface of the terrestrial globe are to be projected, is defined, so as to produce, when the cylinder is developed, a map containing the projected points on the surface of the globe. This cylinder must either contain the terrestrial globe 1 or be secant to it, to obtain projections of each point of the globe on to a point of the projection cylinder. The projected points are defined by their coordinates in a frame of reference of the developed cylinder, namely an abscissa X and an ordinate Y, as shown in FIG. 2 which provides a schematic view of the developed cylinder 2. Clearly, before the cylinder is developed, the abscissa X is a curved line on the cylinder.

The cylinder is chosen by a person skilled in the art according to the reproduction of the map which he wishes to obtain. The parameters used to define the cylinder are its radius and the position and angle of its axis with respect to the terrestrial globe 1. Preferably, a cylinder tangent to the terrestrial globe along the equator will be chosen in this case. The axis of this cylinder thus coincides with the north-south axis of the terrestrial globe 1, which is perpendicular to the plane of the equator 3, the radius of the cylinder being equal to that of the terrestrial globe 1, approximated to a sphere.

A sequence of n+1 limit angles of latitude (θ₀, . . . , θₙ) is defined, thus defining n (n≧2) distinct ranges of latitudes adjacent to each other (each angle, except for θ₀ and θₙ, forming the upper limit of one range and the lower limit of the next range). In this case, the ranges are of constant amplitude, but this is not essential. In particular, their amplitude can decrease as the value of the angles of latitude increases (in absolute terms), to provide a better approximation when approaching the poles. In this case it is assumed that n=9. Each of the north and/or south hemispheres of the globe is divided into n peripheral latitude zones corresponding to the n ranges of the sequence. Thus, in the case in question, the northern hemisphere is divided into a first zone, containing all points on the surface of the globe whose latitude ranges from 0 to 10°, a second zone containing all points on the surface of the globe whose latitude ranges from 10 to 20°, and so on up to a final zone, in which the latitudes of the points range from 80 to 90°. The same operation is carried out on the southern hemisphere, with negative latitudes. The remainder of the description relates solely to the northern hemisphere, but it will be evident that the same operations can be carried out for the southern hemisphere. The nine zones defined in this way are shown on FIG. 1, the angles θ₁, θ₂, θ₃ and θ₉ being represented in a vertical plane P, secant to the terrestrial globe 1. Clearly, each limit angle corresponds to a parallel of limit latitude. A latitude zone extends between every two successive parallels.

A projection function is defined, to associate a point projected on to the projection cylinder with each point on the surface of the terrestrial globe 1. This projection function is used to project the limit parallels of latitude on to the projection cylinder. This function therefore associates each point having the coordinates (φ,θ) on the terrestrial globe with a point having the coordinates (X,Y) in a frame of reference of the projection cylinder. More precisely, it associates an abscissa X with each longitude φ and an ordinate Y with each latitude θ.

This function is a cylindrical projection function. Regardless of the nature of this function, it will always generate distortions in the projection; indeed, it is impossible to project a sphere on to a plane without distortion. With a cylindrical projection function, the projections of the meridians are parallel to each other, as are the projections of the parallels. The function is chosen by a person skilled in the art in accordance with the distortions which he considers acceptable, depending on his requirements and/or constraints. Examples which can be mentioned are equivalent projections, which preserve the areas, conformal projections, which locally preserve the angles, and therefore the shapes, and equidistant projections, which preserve the distances on the meridians. These projection functions require different conditions and equations, which are not all shown in full here.

The method according to the invention is described here in relation to a conformal cylindrical projection. A conformal function must, in particular, satisfy the following condition:
(δX/δφ)²+(δY/δφ)²=cos²(θ)*((δX/δθ)²+(δY/δθ)²)²

A person skilled in the art will be able to choose any cylindrical function which satisfies this condition in order to obtain a conformal projection, in other words one which preserves the angles, and therefore the shapes. Indeed, the advantage of this type of projection in the application to interactive cartography on the Internet is the fact that it preserves shapes, since, in an application for the general public, it is desirable to be able to display a region, a route, etc., without the need for the distances to be perfectly to scale or for the areas to be perfectly in proportion, for example. This choice is therefore entirely compatible with the envisaged application.

In this case, the chosen projection function is the function f, called the Mercator function, which associates, with each point having the coordinates (φ,θ), a projected point having the coordinates (X,Y), where X=fₓ(φ), and Y=f_{y}(θ), where fₓ, and f_{y} are, respectively, the component of the function f which associates an abscissa with a longitude and the component of the function f which associates an ordinate with a latitude. The function f is defined by the following relations:

X=fₓ(φ)=k*φ (where k is a proportionality factor chosen by a person skilled in the art to make the abscissa X proportional to the longitude φ)

Y=f_{y}(θ)=k*log(tan(θ/2+π/4)) (d being in radians in this case)

Such a function yields good projection results, but is very difficult to implement for all points on the surface of the globe in an interactive cartography application on the Internet, owing to the complexity of the corresponding calculations. The function f is therefore used solely to project the parallels of limit latitude on to the projection cylinder. More precisely, only the component f_{y} of the function is calculated, for the latitude of the parallel in question, since the projections of the parallels are “horizontal” on the developed projection cylinder 2, in other words they are constant-ordinate straight lines.

In this case, therefore, the value of the n+1 projected ordinates is calculated, by the projection function f_{y}, for the n+1 latitudes (θ₀, . . . , θₙ) defining the ranges of latitudes. In the case in question, therefore, we calculate f_{y}(0), f_{y}(10), . . . f_{y}(90). The angles are shown in degrees here, for the sake of simplicity, but clearly a person skilled in the art will adapt the above formula according to whether he is implementing the calculations with angles measured in degrees or in radians. It may be noted that f_{y}(90) is equal to +∞, for the purposes of the function f which has been chosen. In fact, this function was chosen because of its satisfactory behaviour up to approximately 80° of latitude, if maps for higher latitudes are not likely to be required. However, if they are required, it is possible either to choose a different function f, or to arbitrarily assign a value to f_{y}(90); the latter solution is envisaged here.

Taking values in degrees for the angles and assuming that k=1, we obtain:

f_{y}(0)=0

f_{y}(10)=10.051160

f_{y}(20)=20.418984

f_{y}(30)=31.472924

f_{y}(40)=43.711503

f_{y}(50)=57.907881

f_{y}(60)=75.456129

f_{y}(70)=99.431965

f_{y}(80)=139.586617

f_{y}(90)=177,780109 (assigned value)

Each point on the surface of the terrestrial globe is then projected into a point on the cylinder, whose ordinate is contained and interpolated between those of the projected parallels of limit latitude, according to the relative latitude of the point between the two parallels. In the preferred embodiment of the invention, the interpolation is a linear interpolation, but clearly any other interpolation can be used. The ordinate of the projected point is thus interpolated between the ordinates of the projections of the two parallels of limit latitude defining the zone containing the point, as a function of the value of the latitude of the point with respect to these limit latitudes on the surface of the globe.

In this case, the ordinate of the projection of each point of the surface of the terrestrial globe on the projection cylinder is therefore calculated by linear interpolation between two of the calculated values shown above, these two values corresponding to the projected ordinates of the parallels whose latitudes define the zone in which the point concerned is located.

In other words, with reference to FIG. 2, let us assume that a point A on the surface of the globe, having the latitude θ, is located in one of the n zones, indicated as 4, shown above, between two parallels 5 and 6, in other words that its latitude θ is within one of the n ranges defined previously. Let us assume that the latitude θ of this point lies within the range defined by the angles of latitude θᵢ and θᵢ₊₁. The ordinate Y of the projected point A′ of this point A on the globe with latitude θ is calculated by linear interpolation between the values of the projected ordinates of the latitudes θᵢ and θᵢ₊₁, in other words by linear interpolation between the value of f_{y}(θᵢ) and that of f_{y}(θᵢ₊₁). FIG. 2 shows the projections 5′ and 6′ of the parallels 5 and 6 on the developed projection cylinder 2.

The projected ordinate of the latitude θ of a point A on the surface of the globe 1 is thus very easily calculated, by an interpolation between the ordinates f_{y}(θᵢ) and f_{y}(θᵢ₊₁) which have actually been calculated, with the projection function f_{y}, for the latitudes θᵢ et θᵢ₊₁. Clearly, this generates an error with respect to the value which would actually be calculated, for the ordinate of the projected point A′ of the point A, with the projection function f_{y}, but this error with respect to the projection function is limited, since it is cancelled out at each latitude θ₀, . . . , θₙ defining one of the n ranges of latitude.

In this case, the interpolation is carried out as follows: for each point A on the surface of the globe having a latitude θ, lying between two latitudes θᵢ and θᵢ₊₁, the Y ordinate on the projection cylinder is determined as follows:
Y=f_{y}(θᵢ)+(θ−θᵢ)*(f_{y}(θᵢ₊₁)−f_{y}(θᵢ))/(θᵢ₊₁−θᵢ)

Clearly, the value f_{y}(θᵢ) is found for the latitude θᵢ, and the value f_{y}(θᵢ₊₁) is found for the value θᵢ₊₁. The error with respect to the function fy is therefore zero at the points As and θᵢ₊₁, and has a limited peak between these two points.

Evidently, the error with respect to the projection function f_{y} decreases as the number n of ranges of latitude increases.

It should be noted that in this case the n ranges are of constant amplitude, in other words θₙ₊₁−θₙ= . . . =θᵢ−θᵢ₋₁= . . . =θ₂−θ₁=δ; in other words, for iε[0,n], θᵢ=i*δ, with δ=100 in this case.

Consequently, the interpolation function can be rewritten in a simpler form:

Y=f_{y}(m*δ)+(θ−m*δ)*(f_{y}((m+1)*δ)−f_{y}(m*δ))/δ, where m is the integer part of θ/δ, in other words θₘ=m*δ defines the lower latitude of the range containing θ.

Additionally, the longitude φ of the point A is associated on the projection cylinder with an abscissa X=k*φ, which is also very easy to determine.

The point A′, which is the projection of the point A having the coordinates (φ,θ), therefore has the coordinates (X,Y) in a frame of reference of the developed projection cylinder 2:
X=k*φ
Y=f_{y}(m*δ)+(θ−m*δ)*(f_{y}((m+1)*δ)−f_{y}(m*δ))/δ, where m is as defined above.

Again, in other words, each point on the surface of the globe, having the coordinates (φ,θ), is associated with a projected point having the coordinates (X,Y) in frame of reference of the developed cylinder, as follows:
X=k*φ
Y=f_{y}(θᵢ)+(θ−θᵢ)*(f_{y}(θᵢ₊₁)−f_{y}(θᵢ))/(θᵢ₊₁−θᵢ), where θᵢ and θᵢ₊₁ are the latitudes of the parallels defining the latitude zone containing the point.

In this case, f_{y}(θ)=k*log(tan(θ/2+π/4))

Thus, in order to find the projected points on the projection cylinder for the points on the surface of the terrestrial globe, it is simply necessary to calculate in advance the n+1 values of the projected ordinates of the latitudes θ₀, . . . , θₙ, after which the coordinates of the projected points are very easily calculated, knowing, on the one hand, the coordinates (φ,θ) of the points on the surface of the globe, and, on the other hand, the values, f_{y}(θ₀), . . . , f_{y}(θₙ) since a simple affine interpolation function is applied for the ordinates and a simple affine function is applied for the abscissas. These calculations are not excessively complicated and are entirely suitable for an interactive cartography application on the Internet.

An example of the implementation of these calculations is shown in the appendix, which reproduces a short program in C language for implementing the method according to the invention.

Once the projected points have been found in this way, it is a very simple matter to implement the methods for dividing the resulting map into tiles, enabling the various portions of the map to be downloaded in an appropriate and economical way over the Internet according to the user's requirements (with movement of the map, enlargement or reduction of the scale, etc.). It is also easy to apply overlays or images to the map, for example in the form of relief, names of the regions, the cities, the streets, etc., which have been projected on to the developed cylinder (indeed, a point A corresponds to a point in a street, on the frontier of a region, etc.), or satellite images. Because of the simple structure of the data defining the developed cylinder, these overlays can be applied independently to each tile.

As shown above, the errors, and consequently the resulting distortions with respect to the projection function, are minimized. This is because, for each limit angle of latitude θ₀, . . . , θₙ defining a range, the value of the projected ordinate is the exact value calculated with the projection function. It is true that this projection function causes some distortions, but these can be kept under control by those skilled in the art, by the choice of the projection function. Furthermore, it is possible to choose a very accurate, and therefore complex, function, since the values of this function are only calculated for the latitudes of the limit parallels of latitude, in advance; depending on the accuracy required, it is also possible to increase the number n of ranges of latitude. When the interpolation is implemented, the true values of the function f are “captured” at each limit angle of latitude θᵢ (iε[0,n]) defining a range. Between two of these angles, the error with respect to this function, in other words with respect to the true value which the ordinates of the projected points would have if the function f were applied to each of the points on the surface of the globe, is limited.

Thus, if a portion of the surface of the terrestrial globe extending over a plurality of latitude zones is projected, the error, with respect to the projection which would be produced for all the points with the projection function f, is limited to the error caused in each of the latitude zones. Thus an approximation of the true projection is found by means of a conformal cylindrical function f, with a minimum of calculation. The projection method is therefore applicable to a field such as that of interactive cartography on the Internet, resulting in distortions which are acceptable to the user. These distortions are entirely quantifiable by those skilled in the art, who can modify the function or the number of zones into which the globe is divided, in order to achieve a greater or lesser degree of accuracy according to their requirements and/or constraints.

It has also been shown that the exact implementation of certain projection functions may be good in one portion of the globe but less good in others; for example, in the case considered, the behaviour of the function is good up to approximately 80° of latitude, but less good between 80 and 90°. Using the method according to the invention, it is possible to assign a value in an arbitrary way (although it will be chosen by a person skilled in the art according to his requirements) to f_{y}(90), to prevent its divergence towards +∞. When the value of f_{y}(90) is fixed in this way, the values taken by the projected ordinates of the points of latitude lying between 80 and 90° are in the range from f_{y}(80) and f_{y}(90), and do not diverge. Thus it is possible to correct errors or to give the projection a desired shape by assigning suitable values to some of the ordinates of the projections of the latitudes θ₀, . . . , θₙ which define the ranges.

The method of the invention has been described with respect to a projection cylinder tangent to the equator; in other words, the scale is preserved at the level of the equator. Clearly, a person skilled in the art can easily adapt the above description in cases in which the cylinder is, for example, secant or tangent to a parallel of latitude θ₀, by introducing correction constants dependent on θ₀. It should be noted that, by contrast with the prior art in which such a value of θ₀ would lead to errors when departed from, the method of the invention is not affected by this factor.

Additionally, an approximation has been made here in that the terrestrial globe is considered to resemble a sphere. Clearly, however, another approximation could be made, for example by approximating the terrestrial globe to an ellipsoid. In this case, the projection function f, preferably a conformal cylindrical projection, is different and more complex. In fact, however, it is only applied to the limit latitude points, the interpolation for the other points on the globe being carried out in a similar way. Thus the invention enables more complex and more accurate approximations to be applied to interactive cartography on the Internet.

A description will now be given, with reference to FIG. 3, of a cartographic projection system 7 for implementing the method of the invention, in the application to the generation of interactive maps on the Internet. This system 7 comprises a database 8 containing cartographic data, from which it is possible to extract the coordinates (φ,θ) of the points on the terrestrial globe, which are stored in a database 9. Thus this database 9 contains the coordinates of the points on the portion of the globe whose display is required.

The coordinates θᵢ, iε[0,n] of the limit angles of latitude are also entered into a database 10. The system 7 comprises a calculation module 11, for calculating the projection of the angles of limit latitude, in other words for calculating f_{y}(θᵢ); this calculation module comprises, for example, a cylindrical projection program, comprising the function f_{y}; these calculated values f_{y}(θᵢ) are stored in a database 12.

A user sends a request to the system 7, via a request input module 13, typically a computer connected to the Internet. This request can be a request to generate a map based on an address, on a portion of the globe, or with any other relevant parameter (scale, possibility of enlargement or reduction, etc.). This request makes it possible to select, from the database 9 containing the coordinates (φ,θ) of the points on the globe, the coordinates of the points to be displayed on the map, which are stored in a database 14 of selected data. These coordinates are entered into a comparison module 15, which compares each selected latitude with the latitudes in the database 10 containing the coordinates of the limit latitudes θᵢ, iε[0,n]. Starting from this comparison module (15), each point is assigned in a zone of the globe between two limit latitude points, its position between these two latitudes being determined; a calculation module 16 can calculate the value of the projected ordinate of this point, by interpolation between the projected values of the latitudes defining the zone in which it is located, as a function of the position of the point in the zone. For this purpose, this calculation module 16 is connected to the comparator 15 and to the database 12 containing the values of the f_{y}(θᵢ). The calculation module 16 also calculates the value of the projected abscissa of the longitude of each point. Thus it enables the projected coordinates (X,Y) of the points to be obtained.

The calculated values of the projected coordinates of the points on the portion of the terrestrial globe are entered into a module 17 for generating maps on the Internet, comprising in this case a function for dividing the map into tiles, as well as any necessary functions for superimposing overlays and/or images. The resulting map is then displayed by means of a display module 18.

In one embodiment, the coordinates θᵢ, iε[0,n] of the limit angles of latitude are entered into the database 10 directly by a person skilled in the art, before any maps are generated, the sequence of limit latitudes thus being fixed for the future. In another embodiment, as shown in FIG. 3 by the link between the request entry module 13 and the database 10, the sequence of coordinates θᵢ, iε[0,n] of the limit angles of latitude is generated automatically by the system 7, according to the user's request. Thus this sequence of coordinates is generated according to the address or the portion of the terrestrial globe which the user wishes to display, or according to the accuracy which he requires, the number of limit latitudes and the intervals between them being adaptable to different circumstances.

Clearly, the system has been described in functional terms, and some of the databases can be combined. The nature and structure of the modules and databases will be determined by persons skilled in the art.

1- Method for the cartographic projection of at least a portion of the terrestrial globe (1), in which a projection cylinder, containing the globe (1) or secant to it, is defined, and the points on the globe, whose coordinates are defined by a longitude (φ) and a latitude (θ) are projected on to this cylinder by associating an abscissa (X) with each longitude (o) and an ordinate (Y), with each latitude (φ) with in a frame of reference of the developed cylinder (2), characterized in that:
a sequence of n+1 angles of latitude (θ₀, . . . , θₙ) is determined, defining n (n≧2) distinct ranges of latitude,
each northern and/or southern hemisphere of the globe (1) is divided into n peripheral latitude zones (4) corresponding to the n ranges of the sequence, each being defined by two parallels (5, 6) of limit latitude,
the parallels of limit latitude (5, 6) are projected on to the projection cylinder, and
each point (A) of one of the n latitude zones (4) is projected into a point (A′) on the cylinder, whose ordinate is contained and interpolated between those of the projected parallels of limit latitude, according to the relative latitude (θ) of the point (A) between the two parallels (5, 6).

2- Method for cartographic projection according to claim 1, in which the cylinder is tangent to the globe (1) along the equator (3).

3- Method for cartographic projection according to claim 1, in which the interpolation is linear.

4- Method for cartographic projection according to claim 1, in which the parallels of limit latitude (5, 6) (θᵢ, iε[0,n]) are projected by a cylindrical projection defined by a function f_{y}, which associates an ordinate with a latitude (θᵢ) on the developed projection cylinder.

5- Method for cartographic projection according to claim 4, in which each point (A) of latitude θ lying in a latitude zone (4) defined by two limit latitudes θᵢ and θᵢ₊₁ (iε[0,n−1]) is associated with a projected point (A′) whose ordinate Y on the developed cylinder is defined by:
Y=f_{y}(θᵢ)+(θ−θᵢ)*(f_{y}(θᵢ₊₁)−f_{y}(θᵢ))/(θᵢ₊₁−θᵢ)

6- Method for cartographic projection according to claim 5, in which the cylindrical projection function f_{y} is a conformal cylindrical projection.

7- Method for cartographic projection according to claim 1, in which the terrestrial globe (1) is approximated to a sphere.

8- Method for cartographic projection according to claim 7, in which the cylindrical projection function f_{y}, which associates, with each latitude θᵢ of a parallel of limit latitude, an ordinate Y on the developed cylinder, is defined by:
Y=f_{y}(θᵢ)=k*log(tan(θ/2+π/4)), where k is a proportionality factor.

9- Method for cartographic projection according to claim 1, in which, with each point (A) on the globe (1) having a longitude φ, is associated a projected point (A′) whose abscissa X on the developed projection cylinder (2) is determined by: X=k*φ, where k is a proportionality factor.

10- Method for cartographic projection according to claim 1, in which the n ranges are of constant amplitude, in other words θₙ₊₁−θₙ= . . . =θᵢ−θᵢ₋₁= . . . =θ₂−θ₁=δ;
in other words, for iε[0,n], θᵢ=i*δ.

11- Method for cartographic projection according to claim 10, in which 6=10°.

12- Method for cartographic projection according to claim 1, which is applied to interactive cartography on the Internet.

13- Method for cartographic projection according to claim 12, in which the resulting map is divided into tiles.

14- Method for cartographic projection according to claim 13, in which an overlay and/or an image is superimposed on the tiles.

15- Map produced by the projection method of claim 1.

16- System for cartographic projection of at least a portion of the terrestrial globe, for the implementation of the method of claim 12, comprising:
a database (9) comprising the coordinates of the points on the portion of the globe, each defined by a longitude (φ) and a latitude (θ),
a database (10) containing the latitude coordinates of a sequence of n+1 limit angles of latitude (θᵢ, iε[0,n]),
a cylindrical projection program, which associates an ordinate (f_{y}(θ)) with each latitude (θ),
a module (11) for calculating, by means of the program, the projected ordinates (f_{y}(θᵢ)) of the n+1 limit angles of latitude,
a module (15) for comparing the coordinates of the points on the portion of the globe with the database (10) containing the coordinates of the limit latitudes of the sequence,
a module (16) for calculating the projected coordinates of the points on the portion of the globe, designed to calculate the projected ordinate of each point by interpolation between the values of the projected ordinates of the angles of limit latitude between which the latitude of the point is located, and
a module (17) for generating an interactive map on the Internet on the basis of the calculated values of the projected coordinates.
